(19) United States
(12) Patent Application Publication
(10) Pub. No.: US 2014/0058713 A1
(43) Pub. Date: Feb. 27, 2014

(54) SEISMIC MODELING SYSTEM AND METHOD

(71) Applicant: Schlumberger Technology Corporation, Sugar Land, TX (US)

(72) Inventors: Manoj Vallikkat Thachaparambil, Kerala (IN); Renchu Wu, Beijing (CN); Dong Wang, Beijing (CN); Rui Zeng, Beijing (CN); Zhigao Zhu, Beijing (CN)

(73) Assignee: Schlumberger Technology Corporation, Sugar Land, TX (US)

(21) Appl. No.: 13/945,997

(22) Filed: Jul. 19, 2013

Related U.S. Application Data
(60) Provisional application No. 61/691,739, filed on Aug. 21, 2012.

(51) Int. Cl. G01V 1/28

(52) U.S. Cl. CPC G01V 1/282
USPC 703/10

(57) ABSTRACT

The present disclosure describes a system, method and computer readable medium capable of extracting, characterizing and modeling fracture networks in a subterranean formation. In one embodiment, seismic data points indicating one or more discontinuities in the subterranean formation may be identified using processed seismic data and arranged according to a tree structure. In one embodiment, connection criteria and/or one or more user parameters may be utilized to identify and connect discontinuity points. In one embodiment, the connected discontinuity points may be utilized to generate discontinuity planes. In one embodiment, one or more of the extracted discontinuity planes may be characterized according to their directional characteristics, intersectional characteristics, shape, dipping characteristics, length/distribution, fracture density, and/or fault type. The extracted discontinuity planes may be converted from a seismic scale model into a sub-seismic scale model.

### CROSS REFERENCE TO RELATED APPLICATIONS

This patent application claims priority upon and incorporates by reference herein, a provisional patent application entitled “Automatic Extraction And Characterization Of Fault And Fracture Populations,” filed on Aug. 21, 2012, Ser. No. 61/691,739.

### BACKGROUND

Computer modeling and simulation of seismic data is a vital component of oil and gas exploration. Such systems conduct some form of computational processing upon acquired data pertaining to a subterranean formation and then export the processed data to one or more data visualization application(s) for review by authorized personnel. Such systems may also use a color mapping structure to generate graphic visualizations of acquired data to assist users in interpreting and/or analyzing the data.

Information concerning the presence of fractures and/or faults within the subterranean formation may be analyzed in order to enable better decision making for optimum well placement and/or production management. Unfortunately, known methods have a number of limitations with respect to analyzing and interpreting fracture network properties.

As such, there remains a desire for a system and method capable of extracting, characterizing and modeling fracture networks in the subterranean formation.

### SUMMARY

Accordingly, the present disclosure describes a system, method and computer readable medium capable of extracting, characterizing and modeling fracture networks in the subterranean formation. As such, one embodiment of the invention extracts a discontinuity plane from seismic data pertaining to a subterranean formation. The extracted discontinuity plane is then characterized and modeled.

Data pertaining to a subterranean formation may be received and stored. In one embodiment, raw seismic data may be processed into attribute cube data and displayed to the user via graphic user interface(s). In one embodiment, discontinuity planes may be extracted from the seismic data. In one embodiment, seismic data points indicating a discontinuity in the subterranean formation may be identified using the processed seismic data and arranged according to a tree structure.

In another embodiment, the invention includes a subterranean formation modeling system. The system includes a computer processor that extracts a discontinuity plane from seismic data pertaining to a subterranean formation and characterizes the extracted discontinuity plane with respect to direction, shape, length, intersection, dip, or fault type. The computer process also models the extracted discontinuity plane.

Another embodiment includes a computer-readable storage medium for modeling a subterranean formation. The medium includes instructions that, when executed, cause a computing device to extract a discontinuity plane from seismic data that, in turn, is in the seismic scale. The instructions also characterize extracted discontinuity plane and model it in the sub-seismic scale.

This summary is provided to introduce a selection of concepts in a simplified form that are further described herein. This summary is not intended to identify key or essential features of the claimed subject matter, nor is it intended to be used as an aid in determining the scope of the claimed subject matter.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings; it being understood that the drawings contained herein are not necessarily drawn to scale and that the accompanying drawings provide illustrative implementations and are not meant to limit the scope of various technologies described herein; wherein:

FIG. 1 is a flowchart diagram illustrating a discontinuity plane extraction process of one embodiment.

FIG. 2 illustrates connected discontinuity points of one embodiment.

FIGS. 3illustrates extracted discontinuity planes of one embodiment.

FIG. 4a illustrates a 3D mesh of one embodiment.

FIG. 4b illustrates horizontal planes of one embodiment.

FIG. 4c illustrates sample lines of one embodiment.

FIG. 4d illustrates sample points representing a sample line of one embodiment.

FIG. 4e illustrates sample lines and sample points of one embodiment.

FIG. 4f illustrates a salt dome representation of one embodiment.

FIG. 5a illustrates an input seismic cube of one embodiment.

FIG. 5b illustrates a preview of expected output based on a parameter setting to extract connected points on an Ant Track input cube of one embodiment.

FIG. 5c illustrates an extracted fracture network of one embodiment.

FIG. 5d illustrates a fracture network extraction along two well trajectories.

FIG. 5e illustrates a fracture network extraction along a surface of one embodiment.

FIG. 5f illustrates a fracture network extraction within a polygon of one embodiment.

FIG. 6a illustrates an intersection view of extracted planes of one embodiment.

FIG. 6b illustrates an alignment stereo-plot of one embodiment.

FIG. 6c illustrates a combined plot of fracture dips of one embodiment.

FIG. 6d illustrates an extraction of fracture dips along well trajectories of one embodiment.

FIG. 6e illustrates an estimation of long and short axes on extracted planes of one embodiment.

FIG. 6f illustrates a cross-plot of fracture lengths from different scales of one embodiment.

FIG. 7 is a flowchart diagram illustrating an intersection characterization process of one embodiment.

FIG. 8 is a flowchart diagram illustrating a shape characterization process of one embodiment.

FIG. 9a illustrates a visualization of fracture P10 density (number of fractures/unit length) along a well trajectory sampled from 3D volume in one embodiment.

FIG. 9b illustrates a visualization of fracture P20 density (number of fractures/unit area) along the surface, which also contains the sampled well that was shown in the FIG. 9a, sampled from 3D volume in one embodiment.

FIG. 9c illustrates a visualization of fracture P21 density (cumulative length of fracture traces/unit area) along the surface, which also contains the sampled well shown in the FIG. 9a, sampled from 3D volume in one embodiment.

FIG. 9d illustrates a visualization of fracture P32 density (cumulative area of fracture planes per unit volume) in 3D volume, which contains the sampled well and the surface that shown in FIGS. 9a-c, in one embodiment.

FIG. 10 is a flowchart diagram illustrating a fault type characterization process of one embodiment.

FIG. 11 is a flowchart diagram illustrating a modeling conversion process of one embodiment.

FIG. 12a illustrates an extracted DFN sample of one embodiment.

FIG. 12b illustrates a facies format of the extracted DFN sample of FIG. 12a of one embodiment.

FIG. 12c illustrates a 3D training image of one embodiment.

FIG. 12d illustrates a Multi-point GeoStatistics (MPS) model of one embodiment.

FIG. 12e illustrates a sub-seismic scale DFN model of one embodiment.

FIG. 12f illustrates a quality control comparison of input and output planes of one embodiment.

FIG. 13 is a schematic illustration of a computer system of one embodiment.

### DETAILED DESCRIPTION

In the following description, numerous details are set forth to provide an understanding of various embodiments of the invention. However, it will be understood by those skilled in the art that the invention may be practiced without these details and that numerous variations or modifications from the described embodiments may be possible.

The present disclosure describes embodiments of a method of modeling a subterranean formation, a computer readable medium for modeling a subterranean formation and a computer modeling system. Data pertaining to a subterranean formation may be received and stored. Such data may be received directly from oilfield sensing equipment (10), retrieved from a database (12) and/or a computer readable storage medium (not shown). Many of the examples provided herein discuss the use of seismic data. However, any suitable data concerning the subterranean formation may be utilized, e.g., seismic, magnetic, gravity, etc.

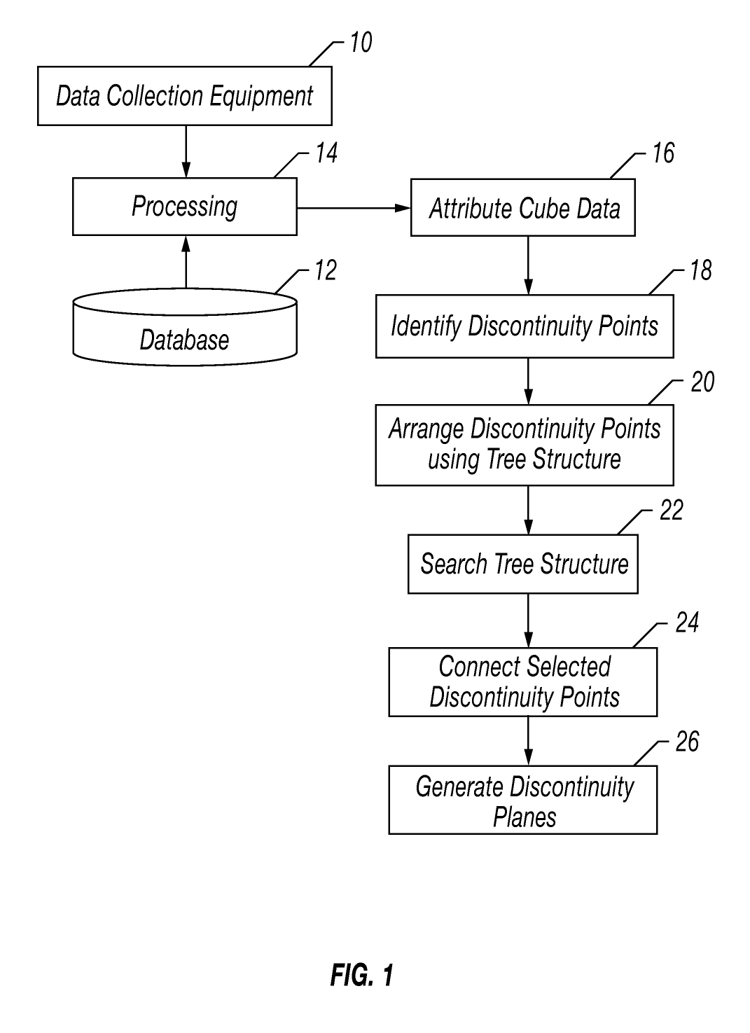

In one embodiment, raw seismic data may be processed into attribute cube data, as illustrated by Boxes (14) and (16) of FIG. 1. The data may conform to one or more grid scheme(s), such as those utilized by the PETREL® system offered by Schlumberger Technology Corporation of Houston, Tex. (hereafter, “PETREL® system”). The attribute cube data may be displayed to the user via one or more graphic user interfaces. This may be accomplished by generating a visual representation of the processed seismic data.

In one embodiment, a data visualization application capable of accessing, processing and displaying acquired seismic data upon one or more graphic user interfaces may be utilized. The data visualization application may be a stand-alone application, such as the PETREL® system or an alternative proprietary data visualization package.

In one embodiment, features of the subterranean formation such as horizons, fractures and faults, may be identified and included in the representation. For example, horizons in the formation, i.e., horizontal or sub-horizontal layers of rock, may be identified by one or more sets of seismic reflectors in lateral succession having similar amplitude values. Faults in the formation, i.e., vertical or sub-vertical breaks in the formation across which there is an observable displacement, may be identified by gaps or disconnections in the seismic reflectors.

In one embodiment, the seismic data may be displayed to the user using a two, three, or four dimensional arrangement. In one embodiment, a two dimensional arrangement may include x and y axis components, a three dimensional arrangement may include x, y, and z components, and a four dimensional arrangement may include x, y, z components along with a time component. Seismic data may be represented utilizing any number of conventions. For example, various color schemes may be utilized to convey the characteristics of the displayed seismic data.

In one embodiment, discontinuity planes may be extracted from the seismic data. In one embodiment, seismic data points indicating one or more discontinuities in the subterranean formation may be identified using the processed seismic data, as illustrated by Box (18) of FIG. 1. The identified discontinuity points may be arranged and stored according to a tree structure, as illustrated by Box (20) of FIG. 1. A k-d tree structure and/or other suitable tree structure may be utilized.

In one embodiment, a searching algorithm may be utilized to search the tree structure in order to identify discontinuity points that may be connected together, as illustrated by Box (22) of FIG. 1. A fast locate search or other suitable searching algorithm may be utilized. In one embodiment, the identified discontinuity points may be connected and used to generate a graphic display of connected discontinuity points for the subterranean formation, as illustrated by Box (24) of FIG. 1.

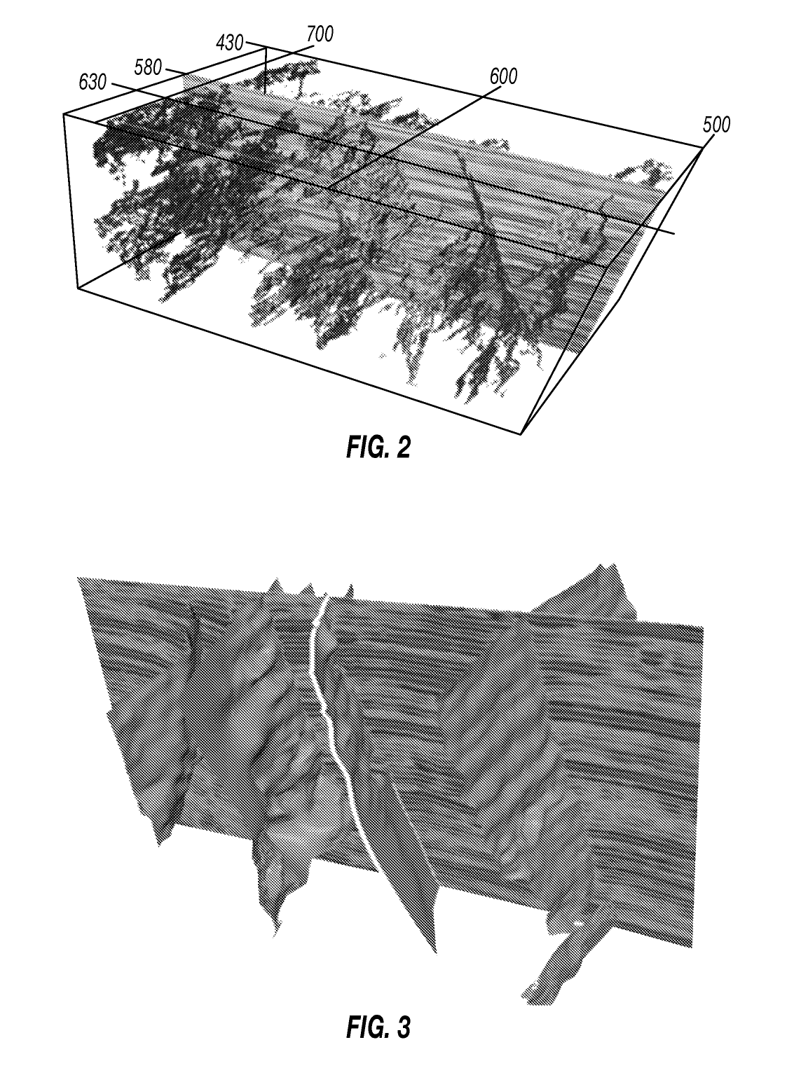

FIG. 2 illustrates an example subterranean formation where a plurality of discontinuity points have been connected and displayed. In one embodiment, connection criteria and/or one or more user parameters may be utilized to identify and connect discontinuity points, as described further below.

In one embodiment, the connected discontinuity points may be utilized to generate discontinuity planes, as illustrated by Box (26) of FIG. 1. FIG. 3 illustrates an example subterranean formation having a plurality of extracted discontinuity planes. In one embodiment, connected discontinuity point data may be interpolated in order to arrive at the extracted discontinuity planes.

In one embodiment, a 3D mesh may be utilized to illustrate extracted discontinuity planes and/or fracture networks in high resolution. One or more of the extracted discontinuity plane(s) may be represented by a data structure. In one embodiment, the data structure used to represent the discontinuity plane(s) may utilize connection criteria, sample lines, and/or coordinate transformation.

Connection criteria may be utilized in order to determine whether two neighboring discontinuity points may be connected. To make the connection flexible, variable sampling intervals in X, Y, and Z directions may be utilized. In one embodiment, the connection criterion may be automatically set to the smallest value that the input data resolution supports to obtain accurate simulation of highly curved shapes. Vertices may also be generated in order to represent the 3D mesh. In one embodiment, vertices may be stored in sample lines.

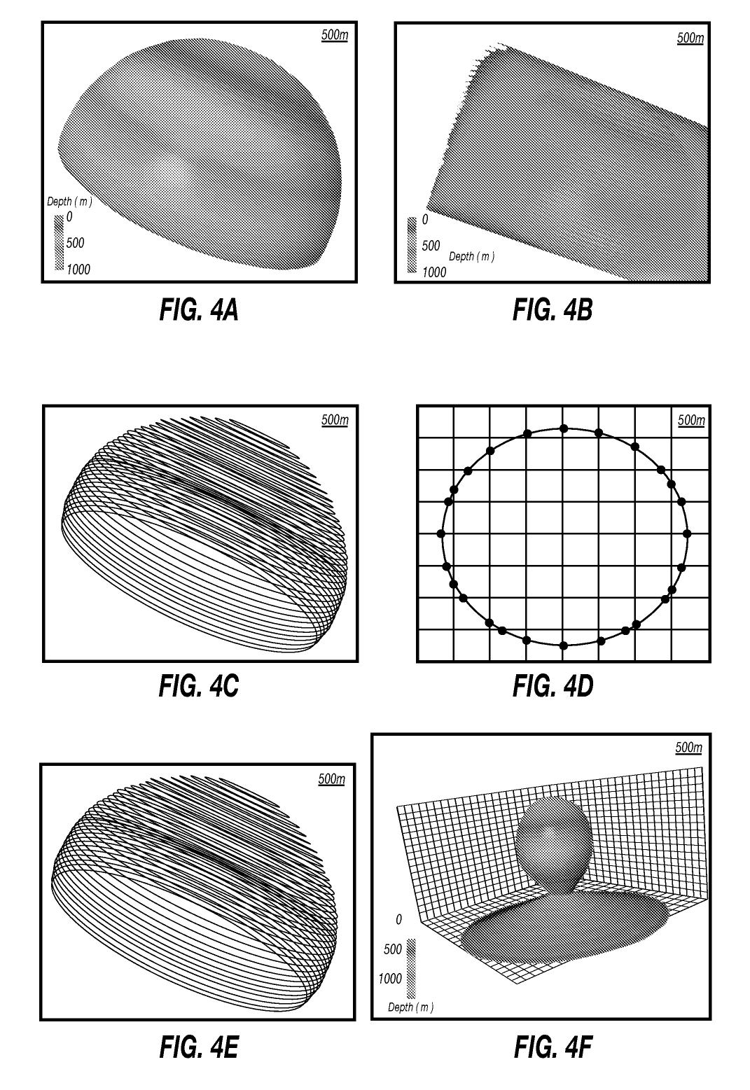

FIGS. 4a-4f illustrate an example procedure for obtaining sample lines in accordance with one embodiment. Using a sample line representation method of one embodiment, a half ball-shaped object (FIG. 4a) and horizontal planes (FIG. 4b) at the vertical interval Z may be used to intersect the original mesh and to obtain multiple sample lines (FIG. 4c) composed of a plurality of circles in this example. Each sample line may be represented by a plurality of structured sample points (FIG. 4d).

In this example, the entire mesh of the half ball shaped object may be represented by sample lines (FIG. 4e). In one embodiment, the local coordinate system of the original mesh may be transformed to the world coordinate system.

In one embodiment, coordinate transformation may include: (1) locating the origin of the local coordinate system in the world coordinate system; (2) defining scale differences between the local coordinate and the world coordinate systems; (3) defining the angle between the x-axes of the local and world coordinate systems; and/or (4) determining whether the local coordinate system is a left or right-handed coordinate system.

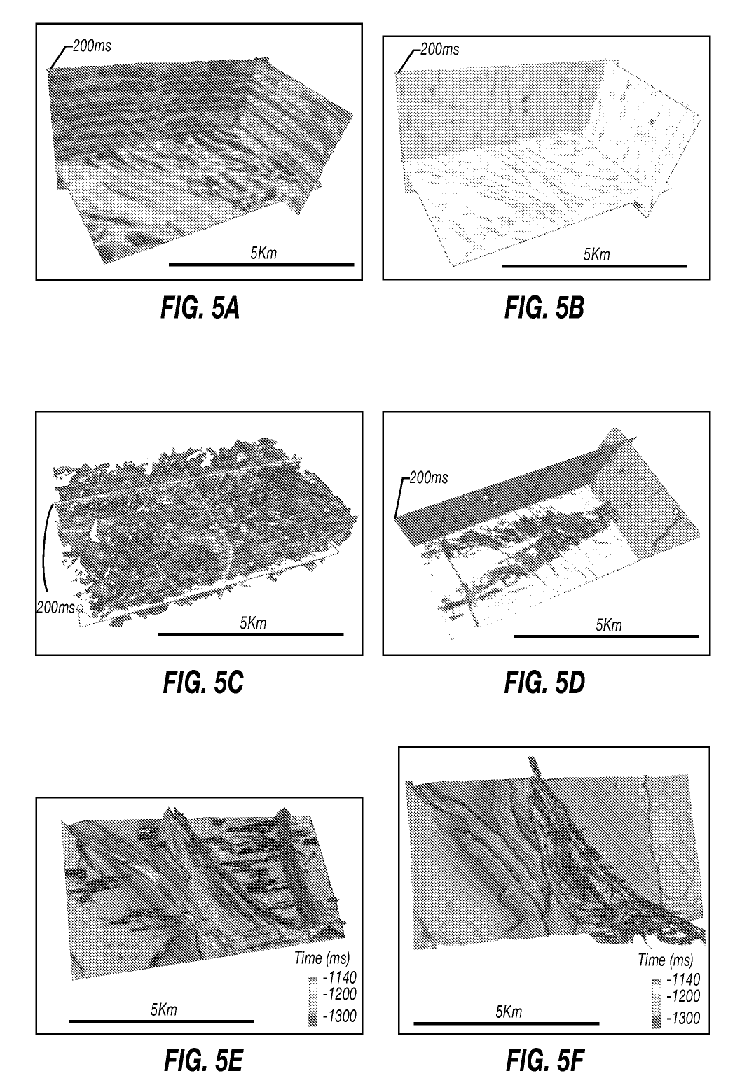

In one embodiment, a rendering algorithm may be utilized to construct triangles between two neighboring sample lines. A process for finding neighboring vertices whose distances are within the connection criteria along the sample lines may be adopted by the rendering algorithm such that complex shapes may be accurately represented, such as salt domes (FIG. 4f) that have sharp turns, multiple Z-values, variable surface attributes, etc. In one embodiment, discontinuity plane(s)may be extracted from the attribute (e.g., Ant Track) cube of post-stack seismic data (FIG. 5a).

Further, the system may utilize one or more user parameters for extracting the fracture population. In one embodiment, the system provides one or more user interfaces through which the user may enter parameters such as spatial limits, attribute thresholds, and/or expected fracture properties such as planarity, waviness, dip, and/or strike. Each change in the parameter selection may be previewed (FIG. 5b) using one or more dimensions (2D in the example of FIG. 5b) before the extraction process is completed. This feature allows the user to verify the anticipated result before running the extraction.

If satisfied with the preview results, the user may run the extraction process (FIG. 5c). Fracture planes and/or networks determined to intersect a planned/drilled well trajectory (FIG. 5d), a particular surface such as a cap-rock boundary (FIG. 5e), an oil-water contact and/or a surface that falls within a polygonal area that may represent a fault block (FIG. 5f) may also be identified and displayed.

In one embodiment, one or more of the extracted discontinuity planes may be characterized by the system. In one embodiment, extracted discontinuity planes may be characterized according to their directional characteristics. For example, discontinuity planes running in a general north-south direction may be characterized in a north-south grouping, while those running in an east-west direction may be characterized in an east-west grouping, etc. This feature allows the user to focus his or her attention on discontinuity planes running in a particular geographical direction, if desired.

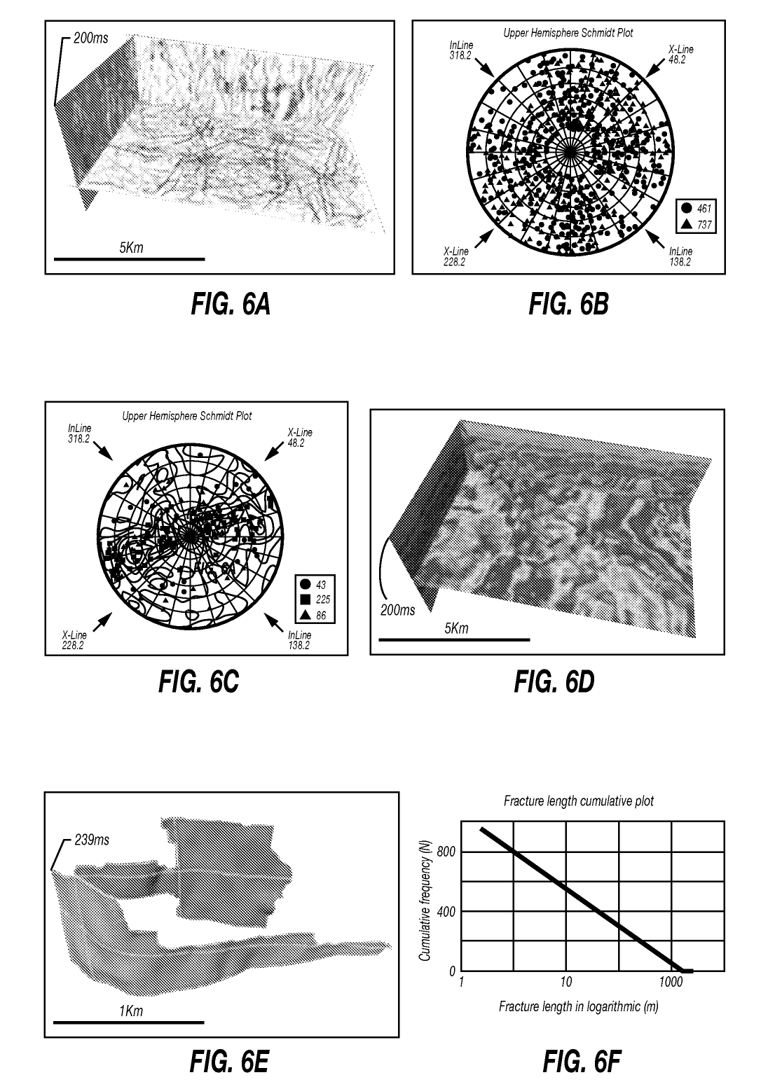

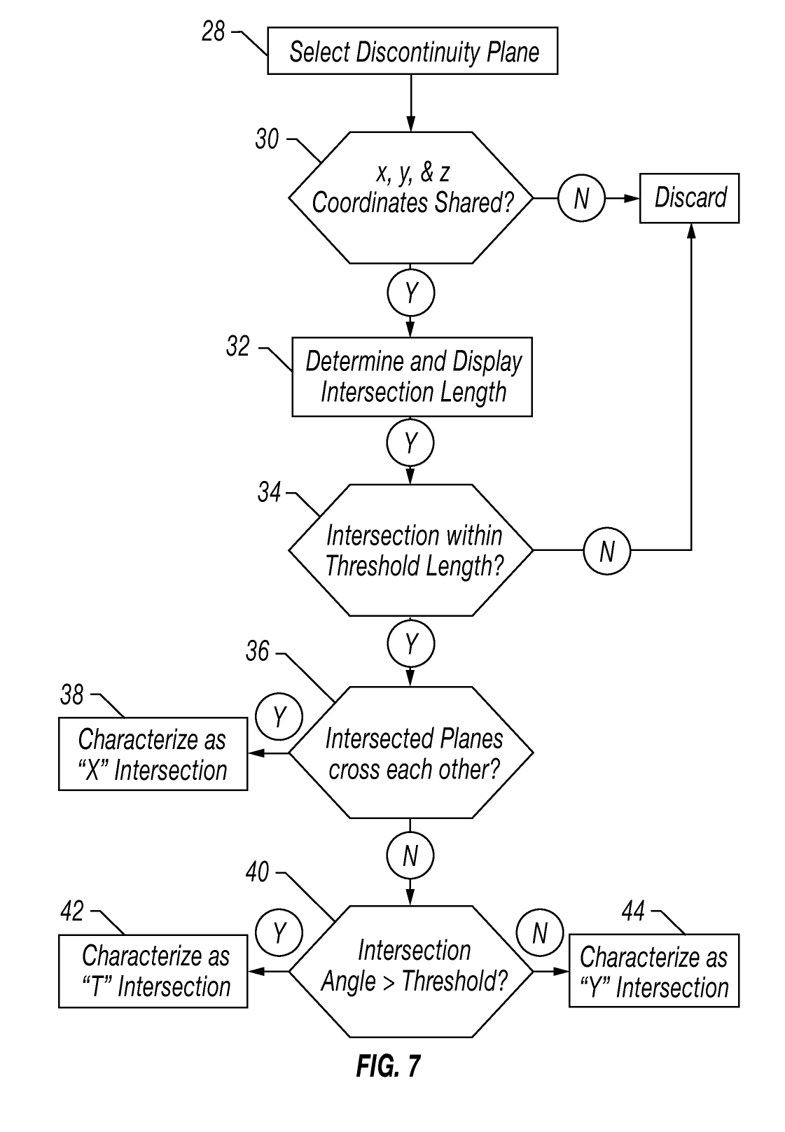

In one embodiment, extracted discontinuity planes may be characterized according to their intersectional characteristics. FIG. 6a provides an example visualization of extracted discontinuity plane intersections in terms of the inline, cross-line, time and depth slices of the input seismic data. In one embodiment, the intersectional characterization process may include a determination regarding whether two or more selected discontinuity planes share x, y and z coordinates, as illustrated by Boxes (28) and (30) of FIG. 7.

If the selected discontinuity planes share x, y and z coordinates, the system may ascertain the length of the intersection of the selected planes and display it to the user, as illustrated by Box (32) of FIG. 7. The length of the intersection of the selected planes may then be compared to one or more user and/or default threshold intersection lengths, as illustrated by Box (34) of FIG. 7. If the intersection length falls within the threshold(s), the system may determine if the planes cross one-another, as illustrated by Box (36) of FIG. 7.

If the planes are determined to cross one-another, the intersection may be characterized as an “X” intersection, as illustrated by Box (38) of FIG. 7. If the selected planes are determined not to cross one-another, the angle of intersection may be ascertained and compared to one or more user/default threshold intersection angles, as illustrated by Box (40) of FIG. 7.

If the intersection angle is determined to be more than the user/default threshold(s), the intersection may be characterized as a “T” intersection, as illustrated by Box (42) of FIG. 7. If the intersection angle is determined not to be less than the user/default threshold(s), the intersection may be characterized as an “Y” intersection, as illustrated by Box (44) of FIG. 7.

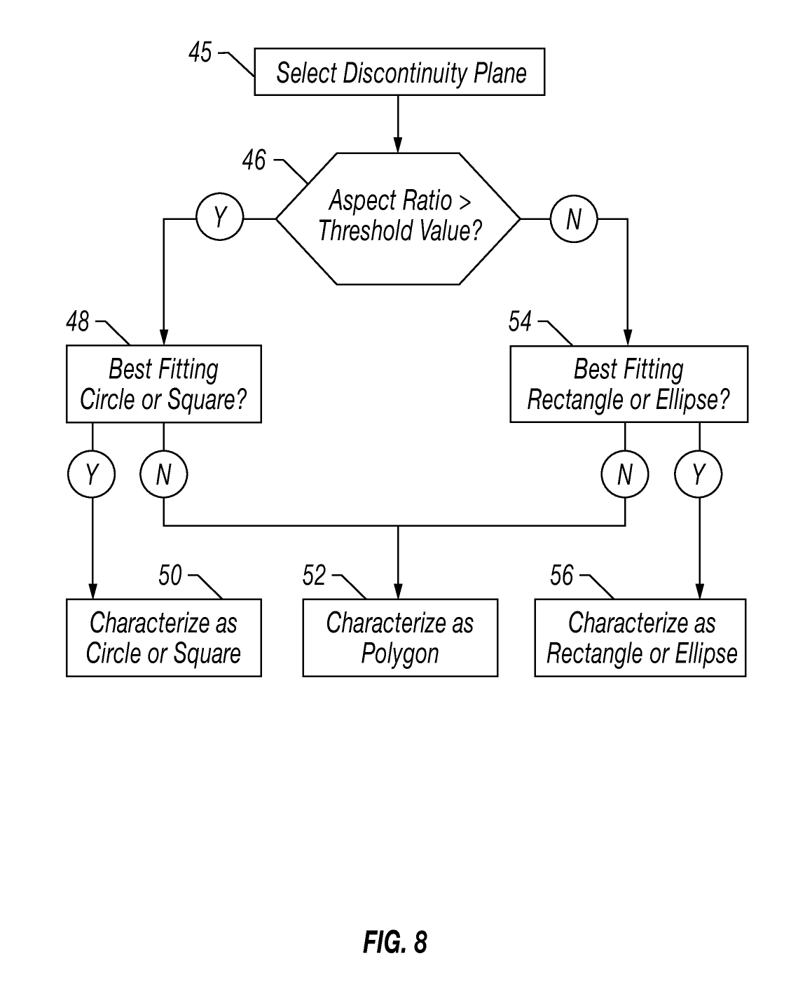

In one embodiment, extracted discontinuity planes may be characterized according to their shape. In one embodiment, the shape characterization process may include a determination regarding whether the aspect ratio of a selected discontinuity plane meets or exceeds a user/default aspect ratio threshold, as illustrated by Boxes (45) and (46) of FIG. 8.

If the aspect ratio of the plane exceeds the threshold value, the system may subject the discontinuity plane to a fitting process to ascertain the best fitting shape for that discontinuity (e.g., a best fitting circle or square shape), as illustrated by Box (48) of FIG. 8. In one embodiment, the system may maintain a library containing a plurality of best fitting shapes for use during the shape characterization process. If a best fitting circle or square shape is identified, the plane in question may be characterized accordingly, as illustrated by Box (50). If no best fitting circle or square shape is identified, the plane may be characterized as a polygon, as illustrating by Box (52).

If the aspect ratio of the plane does not exceed the threshold value, the system may subject the discontinuity plane to a fitting process to ascertain the best fitting rectangle or ellipse shape, as illustrated by Box (54) of FIG. 8. If a best fitting rectangle or ellipse shape is identified, the plane in question may be characterized accordingly, as illustrated by Box (56). If no best fitting rectangle or ellipse is identified, the plane may be characterized as a polygon, as illustrating by Box (52).

In one embodiment, an aspect ratio scale of 0 to 1 may be utilized to denote discontinuity plane shape. In one embodiment, a higher aspect ratio, e.g., 0.9 or higher, may be used to denote planes having geometrically similar dimensions in several directions, e.g., a plane having a circular or square shape, while lower aspect ratio values may be used to denote square and rectangular shaped planes.

Extracted discontinuity planes may also be characterized according to their dipping characteristics. For example, discontinuity planes may be characterized as gently dipping, steeply dipping, etc. Further, the system may generate various plots illustrating the dip characteristics of extracted planes.

Such plots may include, for example, one or more stereo-plots to address artifacts that may be present due to seismic acquisition geometry (FIG. 6b), plane dip plots illustrating dips from well and/or analog fracture data (FIG. 6c), local dip plots illustrating seismic-scale fractures along well trajectories to enable one-to-one comparisons of fracture dips from well logs and cores (FIG. 6d), etc.

In one embodiment, extracted discontinuity planes may be characterized according to their length and/or distribution. This feature may include an estimation of major and minor fracture lengths (FIG. 6e) for one or more selected discontinuity planes. The fracture length (major axis) distribution estimate for each fracture set within the extracted planes may be cross-plotted (FIG. 6f) using fracture lengths obtained from borehole image logs, core samples, and/or borehole seismic data.

Cross-plot(s) may also provide scale-independent fracture-length analysis from various reservoir and/or analog data sources. A best-fit trend line between the uncensored ranges (the slope within the data ranges) of the fracture length(s) (in borehole and/or reservoir scale) may also be generated to provide scale-independent distribution information of fracture lengths for one or more fracture data sets.

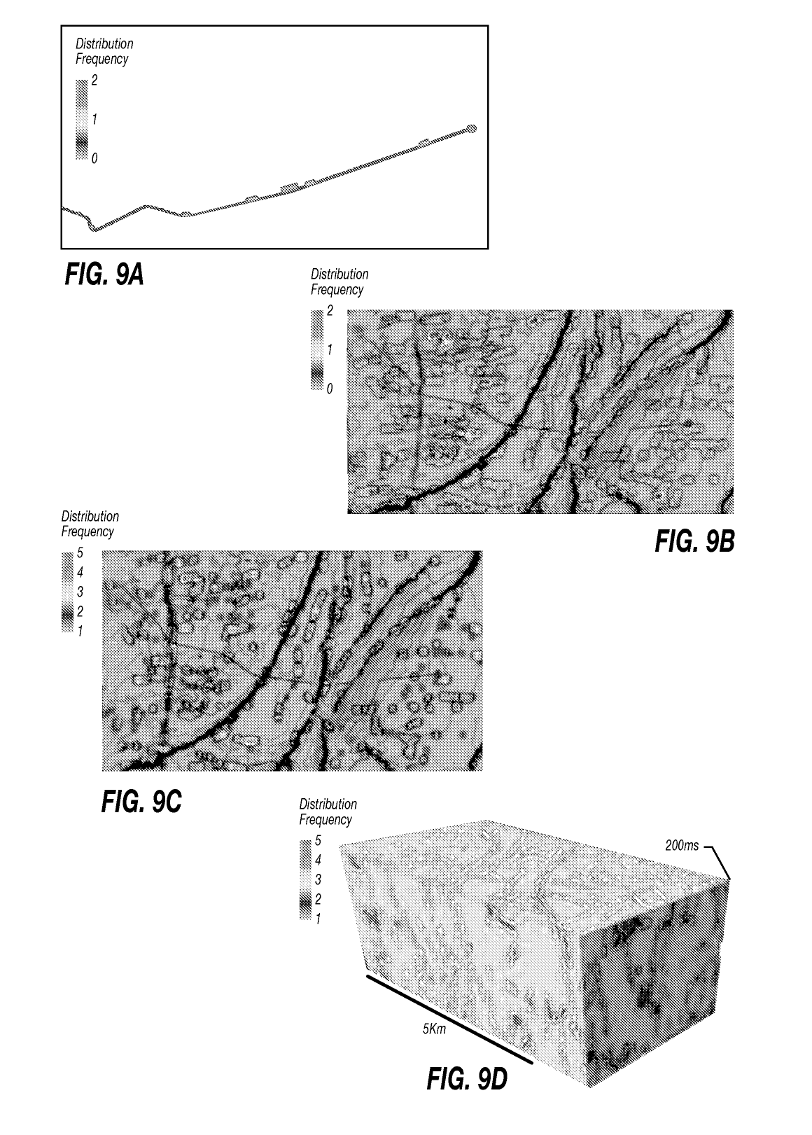

Fracture density may also be considered during the characterization process. Because the fractures may be extracted as 3D networks and planes from 3D seismic data, the extracted fracture density may be sampled using 1D, 2D, and 3D methods. FIGS. 9a-9d illustrate an example multi dimensional density sampling of an extracted in-situ fracture population. Specifically, FIG. 9a illustrates a fracture density (number) along a well trajectory. FIG. 9b illustrates a fracture density (number) along the surface of FIG. 9a. FIG. 9c illustrates the fracture density (length) along the same surface and FIG. 9d illustrates the fracture density (area) in 3D volume.

This feature provides an opportunity to sample a single fracture population in three dimensions, helping the user understand sampling and orientation biases on fracture distribution and density estimations. This may be especially helpful along 1D sampling lines (e.g., in a well).

In one embodiment, extracted discontinuity planes may be characterized according to their fault type. This may involve the generation of a fault displacement cube for one or more of the discontinuity planes in the formation. In one embodiment, the fault displacement cube provides displacement information for each fault while the discontinuity plane provides directional information for each fault. Displacement information and directional information may be used in combination to characterize each plane by fault type.

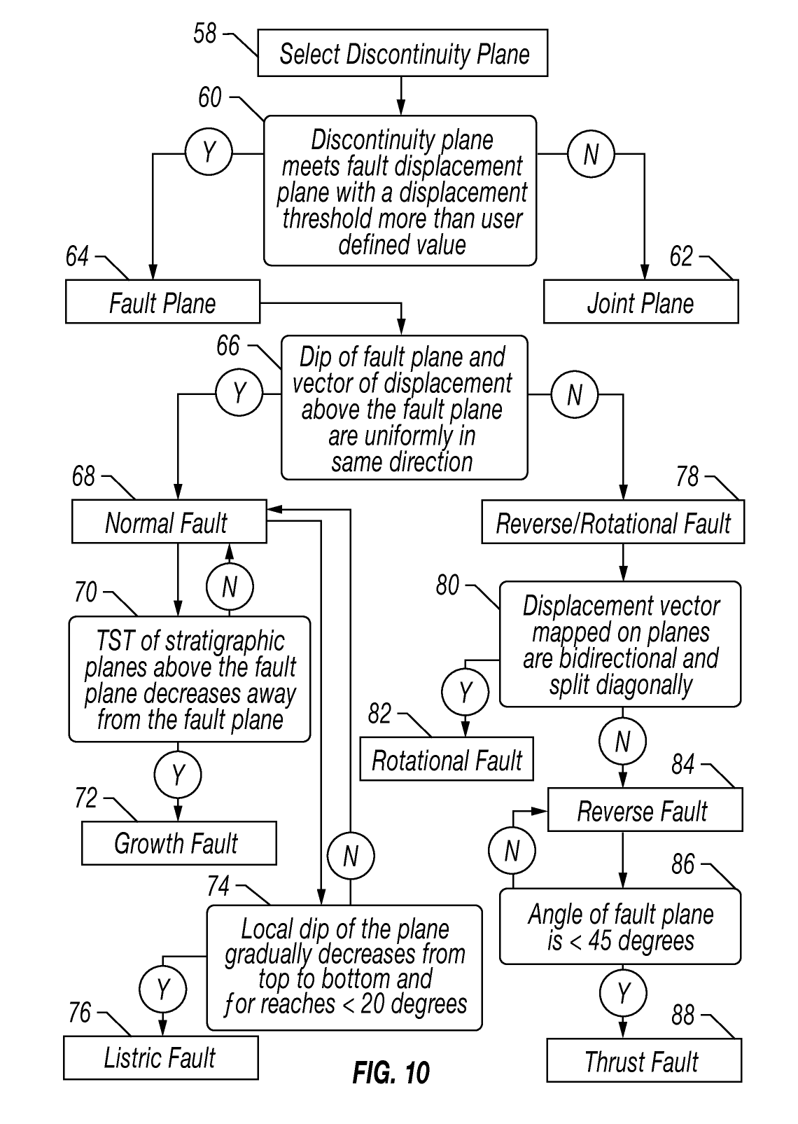

In one embodiment, the fault type characterization process may include a determination regarding whether the displacement of a selected discontinuity plane meets or exceeds a user/default displacement threshold, as illustrated by Boxes (58) and (60) of FIG. 10. In one embodiment, a higher displacement value may exclude planes having small displacement values and vice versa. If the displacement value of the plane does not exceed the threshold value, the selected discontinuity plane may be characterized as a joint plane, as illustrated by Box (62) of FIG. 10.

If the displacement along the plane exceeds the threshold value, the selected plane may be characterized as a fault plane, as illustrated by Box (64) of FIG. 10. The characterized fault plane may be further analyzed to include a determination as to whether the dip of the fault plane and the displacement vector above the fault plane are uniformly in the same direction, as illustrated by Box (66) of FIG. 10. If the dip of the fault plane and the displacement vector above the fault plane are determined to be uniformly in the same direction, the selected plane may be characterized as a normal fault, as illustrated by Box (68) of FIG. 10.

The normal fault plane may be further analyzed to include a determination as to whether the True Stratigraphic Thickness (TST) of the plane above the fault decreases away from the fault plane, as illustrated by Box (70) of FIG. 10. If the TST of the plane above the fault decreases away from the fault plane, the fault may be characterized as a growth fault, as illustrated by Box (72) of FIG. 10.

The normal fault plane may be further analyzed to include a determination as to whether the local dip of the selected plane gradually decreases from top to bottom and/or reaches an angle of less than around 20 degrees, as illustrated by Box (74) of FIG. 10. If the local dip of the selected plane gradually decreases from top to bottom and/or reaches an angle of less than around 20 degrees, the fault may be characterized as a listric fault, as illustrated by Box (76) of FIG. 10.

If the dip of the fault plane and the displacement vector above the fault plane are determined not to be uniformly in the same direction, the selected plane may be characterized as a reverse or rotational fault, as illustrated by Box (78) of FIG. 10. The reverse/rotational fault may be further analyzed to include a determination as to whether the displacement vectors of each plane of the reverse or rotational fault are bidirectional and split diagonally, as illustrated by Box (80) of FIG. 10.

If the displacement vectors of each plane are determined to be bidirectional and split diagonally, the fault may be characterized as a rotational fault, as illustrated by Box (82) of FIG. 10. If the displacement vectors of each plane are determined not to be bidirectional and split diagonally, the fault may be characterized as a reverse fault, as illustrated by Box (84) of FIG. 10.

The reverse fault plane may be further analyzed in order to determine whether the angle of the reverse fault plane is less than around 45 degrees, as illustrated by Box (86) of FIG. 10. If the reverse fault plane is determined to have an angle of less than around 45 degrees, it may be characterized as a thrust fault, as illustrated by Box (88) of FIG. 10.

One or more of the characterizations generated by the system may be utilized as quality control measure(s) at any point in the process described herein, thus further enhancing the usefulness of the system. For example, FIGS. 6a-6e (described above) provide various visualizations of extracted and characterized planes that may be utilized for quality control purposes.

In one embodiment, the extracted discontinuity planes may be drawn to large scale fractures presented to the user in seismic scale. Further, one or more of the extracted discontinuity planes may be represented by a data object. In one embodiment, the extracted fractures may be converted into a Discrete Fracture Network (DFN) model. The DFN model provides a high degree of accuracy regarding fracture positions within each grid and may also provide natural connectivity information and network pattern information.

When converting extracted fracture planes/networks into a DFN model, the system may retain fracture details, such as waviness and intersection properties for each fracture plane. The system may also avoid the use of best-fit 2D planes, which may displace fractures from their in-situ locations and from the corresponding grid.

In one embodiment, the user may select from two DFN-modeling arrangements. First, the user may utilize a fracture plane/set-based modeling arrangement converted into a DFN model according to a seismic scale resolution. Second, he or she may utilize a modeling arrangement wherein the extracted discontinuity planes are converted to sub-seismic scale resolution using a multipoint geostatistics (MPS) modeling arrangement.

Fracture properties from well data may be integrated with the extracted seismic-scale fracture plane/set properties for effective modeling of the entire fracture population. First, the user may check the fracture characteristics on different scales to determine whether the in-situ fracture population exhibits a fractal nature. Based on the results, the user may decide how to integrate the population characteristics from the different scales to create a comprehensive fracture model. Also, the user may extract fracture information, such as unbiased and uncensored fracture length and size distributions, aspect ratio, orientations of long and short axes, and termination proportions and styles, and possible sampling bias in the well data. This information may be useful for effective modeling of subseismic fracture networks within the extracted seismic-scale fracture network.

The system may also allow more precise fault analysis by providing a detailed texture of fault surfaces. Fault planes may be generated using the detailed texture information and used for fault and structural modeling. The user may also convert selected planes into fault sticks or directly into fault planes if desired.

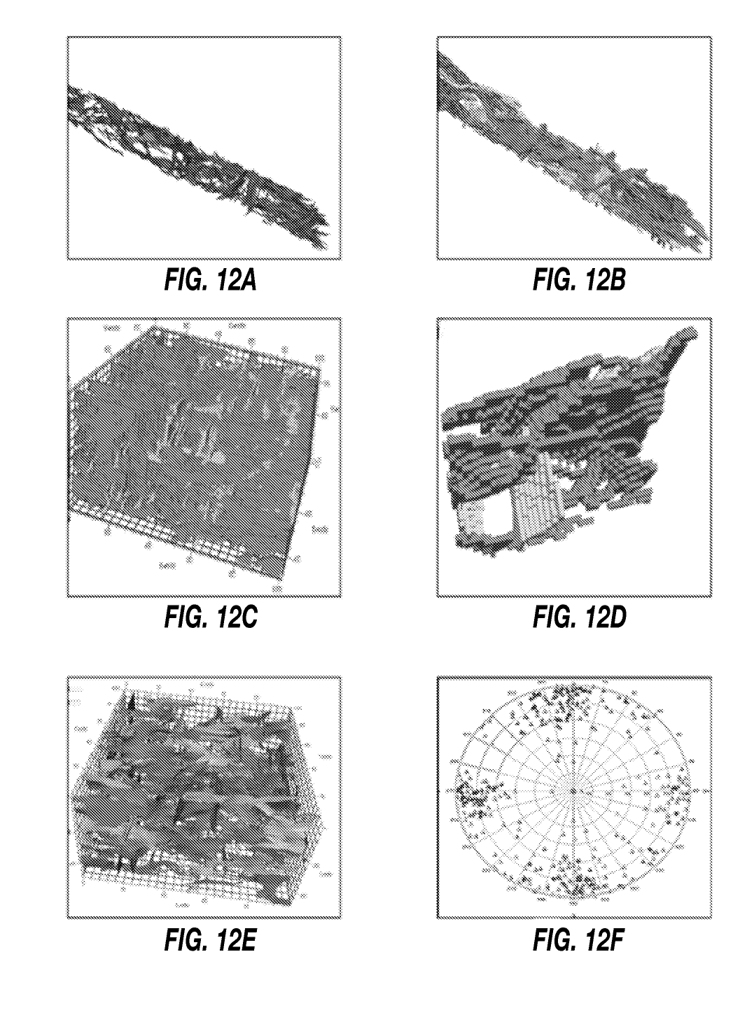

In one embodiment, if the user wishes to utilize a sub-seismic scale arrangement, he or she may select this option via a graphic user interface (not shown). This option may be especially useful if the fractures in the formation exhibit fractal characteristics and the user wants to consider sub-seismic fractures. In one embodiment, the conversion from a DFN seismic scale model to a DFN sub-seismic scale model may be accomplished as follows. FIG. 12a provides an example illustration of extracted DFN discontinuity planes.

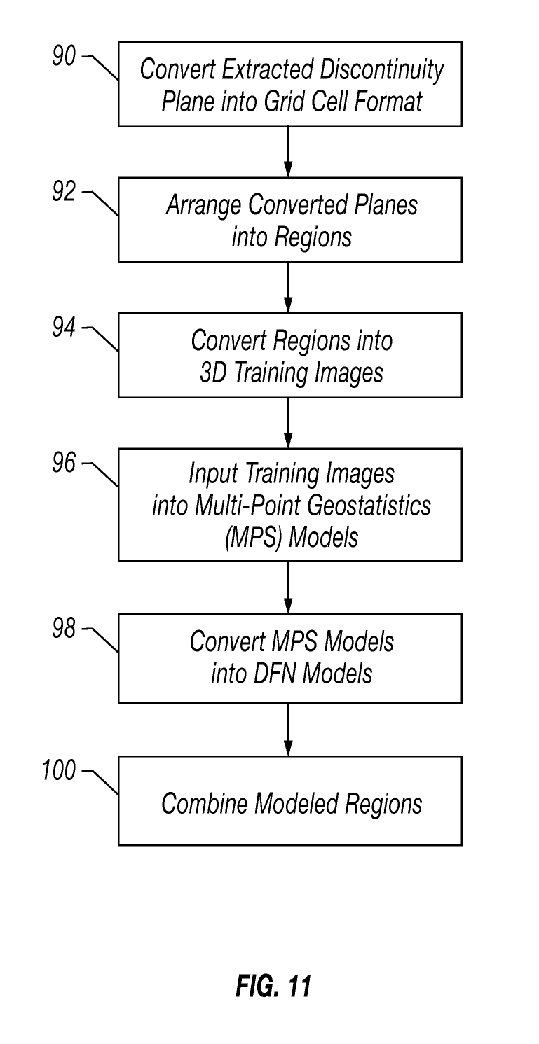

The extracted discontinuity planes may be converted into grid cell format (or facies format) and then divided into sub-sets or regions of grid scale data, as illustrated by Boxes (90) and (92) of FIG. 11. FIG. 12b provides an example illustration of extracted DFN planes converted into grid cell (or facies) format. In this example, each cell in the model may have the same size and map to a point on the planes/surfaces. Further, each cell may map to the same plane/surface having the same cell value.

The division of grid cell data into sub-sets or regions may be accomplished by searching the attributes of the extracted discontinuity planes and grouping regions of the extracted planes according to the characteristics of the fractures and/or fracture planes. One or more of the above described characterizations, e.g., direction, length, shape, etc., may be utilized for this purpose, alone or in combination. For example, regions where discontinuity planes run in a north-south direction may be grouped together in a subset/region due to the similarity of the directional characteristics.

Each region of grid cell data may then be converted into a training image, as illustrated by Box (94) of FIG. 11. FIG. 12c provides an example illustration of a 3D training image. In one embodiment, the system may map the surface distribution to cell values in the training image by: (1) creating a facies model having the same size as the DFN model; (2) obtaining the control points for each plane; (3) setting the value of the facies model cell closest to the control point of the plane index; (4) filling the gap(s) in the cells for the same plane; and (5) the facies model can be regarded as training image directly or may be extracted as the training image.

A Multi-Point geo-Statistics Model (MPS) may then be created using each training image, as illustrated by Box (96) of FIG. 11. The multipoint Geo Statistics methodology developed by Schlumberger Technology Corporation and described in U.S. Patent Application No. 2009/0164182, entitled “Multipoint Geostatistics Method Using Branch Runlength Compression and Local Grid transformation,” Ser. No. 12/341,735, hereby incorporated by reference herein in its entirety, may be utilized for this purpose. FIG. 12d provides an illustration of MPS modeling results for an example training image.

In one embodiment, the MPS modeling operation converts each training image from seismic scale into sub-seismic scale. Each MPS training image model may then be converted back to DFN modeling format, as illustrated by Box (98) of FIG. 11. FIG. 12e provides an illustration of MPS modeling results converted back into DFN format. The training images (each constituting a region of grid cell data) may be combined in order to generate a combined DFN model in sub-seismic scale format, as illustrated by Box (100) of FIG. 11.

FIG. 12f illustrates another quality control feature that may be provided by the system. In one embodiment, a plot of input and output planes may be generated and displayed so that the user may compare the position of input and output discontinuity planes generated by the system. This feature provides a quality check of the modeled DFN by comparing its discrete properties with that of the input DFN/training image. In the example of FIG. 12f, circles are utilized to illustrate the position of input planes while triangles are utilized to illustrate the position of output planes. The example plot of FIG. 12f provides a quality control measure utilizing a comparison of input and output plane locations.

The system may be utilized in conjunction with any suitable data visualization package. Further, the invention may be used at any phase of an oilfield operation including, but not limited to, during the interpretation of seismic data, during modeling of formational characteristics or reservoir properties (including surface modeling), and/or during operational monitoring and analysis activities.

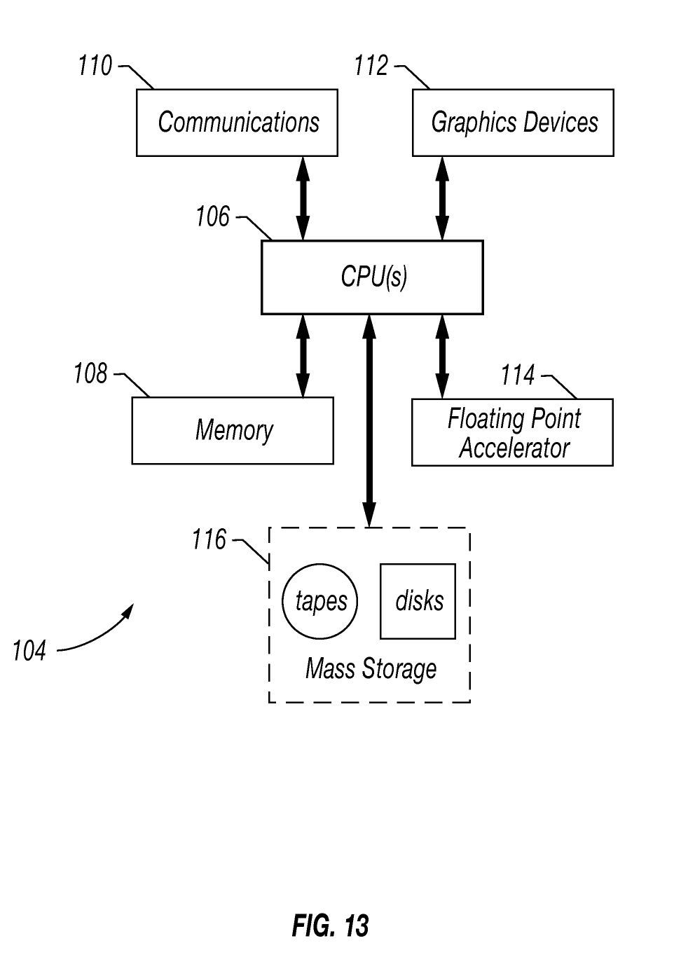

The methods described herein may be implemented on any suitable computer system capable of processing electronic data. FIG. 13 illustrates one possible configuration of a computer system (104) that may be utilized. Computer system(s), such as the example system of FIG. 13, may run programs containing instructions, that, when executed, perform methods according to the principles described herein. Furthermore, the methods described herein may be fully automated and able to operate continuously, as desired.

The computer system may utilize one or more central processing units (106), memory (108), communications or I/0 modules (110), graphics devices (112), a floating point accelerator (114), and mass storage devices such as tapes and discs (116). Storage device (116) may include a floppy drive, hard drive, CD-ROM, optical drive, or any other form of storage device. In addition, the storage devices may be capable of receiving a floppy disk, CD-ROM, DVD-ROM, disk, flash drive or any other form of computer-readable medium that may contain computer-executable instructions.

Further communication device (110) may be a modem, network card, or any other device to enable communication to receive and/or transmit data. It should be understood that the computer system (104) may include a plurality of interconnected (whether by intranet or Internet) computer systems, including without limitation, personal computers, mainframes, PDAs, cell phones and the like.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies.

In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like.

Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

The computer system (104) may include hardware capable of executing machine readable instructions, as well as the software for executing acts that produce a desired result. In addition, computer system (104) may include hybrids of hardware and software, as well as computer sub-systems.

Hardware may include at least processor-capable platforms, such as client-machines (also known as personal computers or servers), and hand-held processing devices (such as smart phones, personal digital assistants (PDAs), or personal computing devices (PCDs), for example). Further, hardware may include any physical device that is capable of storing machine-readable instructions, such as memory or other data storage devices. Other forms of hardware include hardware sub-systems, including transfer devices such as modems, modem cards, ports, and port cards, for example.

Software includes any machine code stored in any memory medium, such as RAM or ROM, and machine code stored on other devices (such as floppy disks, flash memory, or a CD ROM, for example). Software may include source or object code, for example. In addition, software encompasses any set of instructions capable of being executed in a client machine or server.

A database may be any standard or proprietary database software, such as Oracle, Microsoft Access, SyBase, or DBase II, for example. The database may have fields, records, data, and other database elements that may be associated through database specific software. Additionally, data may be mapped. Mapping is the process of associating one data entry with another data entry. For example, the data contained in the location of a character file can be mapped to a field in a second table. The physical location of the database is not limiting, and the database may be distributed. For example, the database may exist remotely from the server, and run on a separate platform.

Further, the computer system may operate in a networked environment using logical connections to one or more remote computers. The logical connections may be any connection that is commonplace in offices, enterprise-wide computer networks, intranets, and the Internet, such as local area network (LAN) and a wide area network (WAN). The remote computers may each include one or more application programs.

When using a LAN networking environment, the computer system may be connected to the local network through a network interface or adapter. When used in a WAN networking environment, the computer system may include a modem, wireless router or other means for establishing communication over a wide area network, such as the Internet.

The modem, which may be internal or external, may be connected to the system bus via the serial port interface. In a networked environment, program modules depicted relative to the computer system, or portions thereof, may be stored in a remote memory storage device.

Although the preceding description has been described with reference to particular means, materials and embodiments, it is not intended to be limited to the particulars disclosed herein; rather, it extends to all functionally equivalent structures, methods and uses, such as are within the scope of the appended claims.

What is claimed is:

1. A computer implemented method of modeling a subterranean formation comprising:
extracting one or more discontinuity planes from seismic data pertaining to a subterranean formation;
characterizing one or more of the extracted discontinuity planes; and
modeling one or more of the extracted discontinuity planes.

2. The computer implemented method of claim 1, further comprising:
identifying one or more discontinuity points represented by the seismic data;
arranging at least a portion of the discontinuity points into a tree structure;
searching the tree structure in order to identify discontinuity points satisfying one or more connection criteria;
connecting discontinuity points satisfying one or more of the connection criteria; and
generating the extracted discontinuity planes using the connected discontinuity points.

3. The computer implemented method of claim 2, further comprising:
interpolating the connected discontinuity points.

4. The computer implemented method of claim 2, wherein the tree structure further comprises a k-d tree structure.

5. The computer implemented method of claim 1, further comprising:
applying one or more user parameters.

6. The computer implemented method of claim 5, wherein the user parameters comprise a spatial limit, attribute threshold or a fracture property.

7. The computer implemented method of claim 1, wherein the extracted discontinuity planes are characterized according to direction, shape, length, intersection, dip, or fault type.

8. The computer implemented method of claim 1, wherein one or more of the extracted discontinuity planes are represented by a data object.

9. The computer implemented method of claim 1, wherein the extracted discontinuity planes are modeled in sub-seismic scale.

10. The computer implemented method of claim 8, further comprising:
converting one or more of the extracted discontinuity planes from seismic scale to sub-seismic scale;
applying a multipoint geostatistics model (MPS) to the converted discontinuity planes; and
applying one or more quality control measures to the modeled discontinuity planes.

11. The computer implemented method of claim 1, wherein the seismic data further comprises seismic cube data.

12. A subterranean formation modeling system comprising:
a computer processor operative to:
extract one or more discontinuity planes from seismic data pertaining to a subterranean formation;
characterize one or more of the extracted discontinuity planes; wherein the extracted discontinuity planes are characterized according to direction, shape, length, intersection, dip, or fault type; and
model one or more of the extracted discontinuity planes.

13. The subterranean formation modeling system of claim 12, wherein the processor is operative to identify one or more discontinuity points represented by the seismic data, arrange at least a portion of the discontinuity points into a tree structure and search the tree structure in order to identify discontinuity points satisfying one or more connection criteria.

14. The subterranean formation modeling system of claim 13, wherein the processor is operative to connect discontinuity points satisfying one or more of the connection criteria and generate extracted discontinuity planes using the connected discontinuity points.

15. The subterranean formation modeling system of claim 12, wherein the processor is operative to apply one or more user parameters comprising a spatial limit, an attribute threshold or a fracture property.

16. A computer-readable storage medium for modeling a subterranean formation comprising instructions which, when executed, cause a computing device to:
extract one or more discontinuity planes from seismic data pertaining to a subterranean formation, wherein the seismic data is in seismic scale;
characterize one or more of the extracted discontinuity planes; and
model one or more of the extracted discontinuity planes in sub-seismic scale.

17. The computer-readable storage medium of claim 16, wherein the instructions, when executed, cause the computer device to convert the extracted discontinuity planes from seismic scale to sub-seismic scale, apply a multipoint geostatistics model (MPS) to the converted discontinuity planes and apply one or more quality control measures to the modeled discontinuity planes.

18. The computer-readable storage medium of claim 16, wherein the tree structure further comprises a k-d tree structure.

19. The computer-readable storage medium of claim 16, wherein the extracted discontinuity planes are characterized according to direction, shape, length, intersection, dip, or fault type.

20. The computer-readable storage medium of claim 16, wherein one or more of the extracted discontinuity planes are represented by a data object.
